(19) United States
(12) Patent Application Publication
(10) Pub. No.: US 2006/0170210 A1
(43) Pub. Date: Aug. 3, 2006

(54) Sanitary element

(76) Inventor: Juergen Gross, Steinach (DE)

Correspondence Address: DUANE MORRIS, LLP;IP DEPARTMENT, 30 SOUTH 17TH STREET, PHILADELPHIA, PA, 19103-4196, US

(21) Appl. No.: 11/321,375

(22) Filed: Dec. 29, 2005

(30) Foreign Application Priority Data
Jan. 4, 2005 (DE) 102005001301.5

(51) Int. Cl. F16L 27/04; F16L 5/00; F16L 27/00

(52) U.S. Cl. 285/138.1

(57) ABSTRACT

In order to fit a side shower to a pipe, it is proposed to provide the side shower with a connecting nipple for a coupling element, the coupling element having a coupling nipple which can be inserted into the hole from outside with two latch tongues. The latch tongues then engage behind the rims of the hole. As a result of the insertion of the connecting nipple of the side shower, the latch bosses are then prevented from springing inward, so that the connection is secured.

Shower installations are becoming increasingly complex, so that it is even possible to speak of shower systems. In addition to the traditional hand showers and overhead showers, side showers are also desired, which are designed to be installed with low spatial requirement. For example, the side showers are fitted to pipes through which the water is also simultaneously conducted to the side shower. Pipes have the characteristic that the rear side of an opening in which the side shower is meant to be fitted can be accessed only with difficulty.

The object of the invention is to provide a facility for fitting a sanitary element with low effort at a place where it is not possible to gain access to the rear side of the opening into the water-carrying system.

In order to achieve this object, the invention proposes an arrangement having the features stated in claim 1. Refinements of the invention are the subject of sub claims.

The arrangement now therefore looks such that a coupling element is provided, which is connected to the pipe. Once the coupling element is connected to the pipe, the sanitary element is then connected to the coupling element using a connecting nipple. The connecting nipple can here also serve to effect a definitive securement of the coupling element to the pipe.

For the securement of the coupling element, it can be envisioned in one refinement that the coupling nipple has at least one latch boss acting upon the rear side of the hole rim. This latch boss springs back as the coupling nipple is applied and then, once the coupling nipple has reached its correct position, engages behind the hole rim. The connecting nipple subsequently connected to the coupling nipple can then serve to prevent the latch boss from springing back.

It can particularly be envisioned that the latch boss is configured on a latch tongue, which is configured such that it springs inward.

In one refinement of the invention, the outer sleeve surrounding the coupling nipple on the outside can have a bearing shoulder for the coupling nipple which is orientated oppositely to the bearing surface of the outer sleeve for the pipe.

In another refinement of the invention, it can be envisioned that the coupling nipple forms or has a socket for the connecting nipple. In particular, this socket, in conjunction with the connecting nipple, can have a bayonet device.

In one refinement, the invention proposes to configure the connecting nipple and/or the coupling nipple such that the connecting nipple, in the inserted state, reaches at least into the hole in the pipe. This not only results in the maximum possible connection length between coupling nipple and connecting nipple, but also serves to prevent the latch tongues from springing back.

It is particularly favorable if the coupling nipple has two latch bosses and two latch tongues, respectively, which are disposed diametrically opposite one another.

According to the invention, it can be envisioned in pipes of circular or oval cross section, in one refinement, that the connection between the outer sleeve and the coupling nipple is configured such that the latch bosses of the coupling nipple are disposed at the place on the outer sleeve where this has its least extent in its own axial direction. Since the bearing surface of the outer sleeve which is intended to bear against the surface of the pipe is matched to the surface of the usually circular cylindrical pipe, there is a place of least axial extent of the sleeve. The latch bosses are then disposed at this place.

For further improvement, it can be envisioned according to the invention that an inner sleeve can be inserted into the coupling nipple in order to block the latch tongues once the coupling nipple is inserted in the hole in the pipe. Although the latch tongues, when the connecting nipple is inserted, are prevented by this from springing back, the arrangement proposed by the invention does offer the prospect of re-releasing the connecting nipple from the bayonet device and pulling it out. In order that the coupling element can remain on the pipe and is safely secured there in this state also, the inner sleeve can then assume the function of blocking the latch bosses.

According to the invention, it can be envisioned that the inner sleeve, upon the insertion of the connecting nipple, is pushed forward until assuming its correct position.

The invention proposes to prefabricate the coupling nipple, the outer sleeve and the inner sleeve as a structural unit. In this case, the inner sleeve is still disposed on the outer end of the socket so as not to prevent the latch tongues from springing back during assembly.

At its end jutting out of the coupling element, the connecting nipple can have a ball joint for the fitting of a side shower. It is also possible, however, for the connecting nipple to merge into an elbow for the coupling of a hose or the like.

The arrangement proposed by the invention is used as follows. Into a pipe a hole is drilled at the place where a side shower or some other sanitary element is to be attached. The projecting part of the coupling element which is provided with the latch tongues is then forced into the hole until that bearing surface of the outer sleeve which is assigned to the pipe bears against the outer side of the pipe. Upon this, the latch tongues then engage with their latch bosses behind the rim of the hole. Inserted in a space between the coupling nipple and the outer sleeve is a molded seal, which is then simultaneously brought into its correct position. Following this fitting of the coupling element, the connecting nipple is introduced into the socket, whereupon it pushes the inner sleeve forward. The connecting nipple is then turned in order to engage the bayonet device. The assembly is thereby completed. The connecting nipple can also be re-released, whereupon the inner sleeve then ensures that the coupling element remains connected to the pipe.

Further features, details and preferences of the invention emerge from the claims and the abstract, both of whose wording is formulated by reference to the content of the description, the following description of a preferred embodiment of the invention and with reference to the drawing, in which:

FIG. 1 shows a section through a side shower fitted to a pipe;

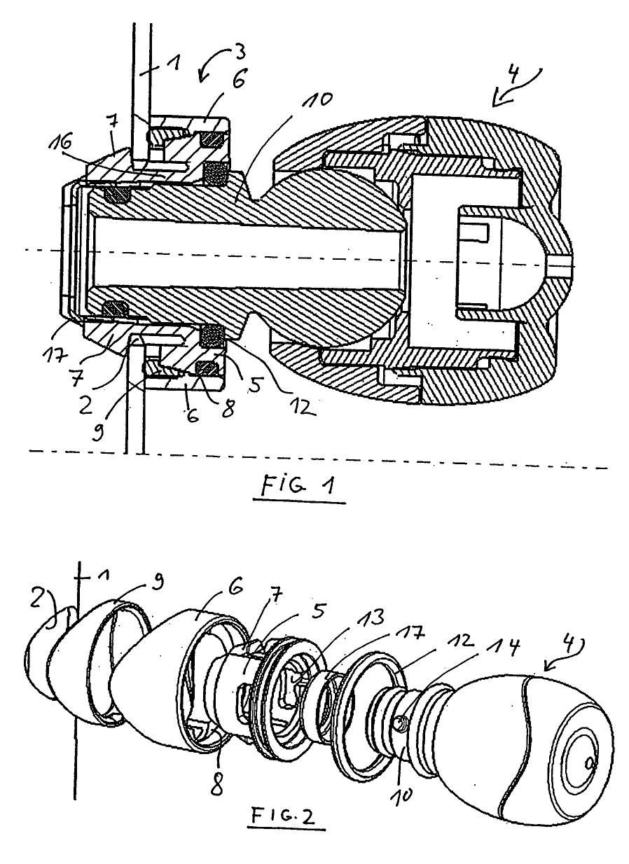

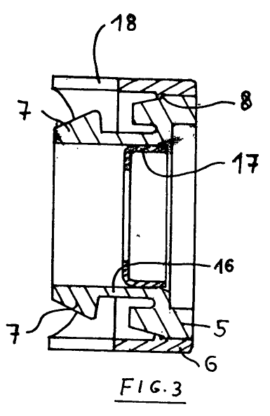

FIG. 2 shows in an exploded representation the individual parts of the arrangement according to FIG. 1;

FIG. 3 shows a section through the coupling element of the arrangement of FIG. 1 in the form of a structural unit.

In the section of FIG. 1 can be seen the wall 1 of a pipe, in which a hole 2 is drilled. Connected to the pipe 1 in the region of the hole 2 is a coupling element 3, which serves the fitting of a side shower 4. The coupling element 3 contains a coupling nipple 5, which is surrounded on the outside by an outer sleeve 6. The coupling nipple 5 has two latch tongues 16, which, in the region of their free end, are provided with a latch boss 7. These two latch tongues 16 are disposed lying diametrically opposite one another. The orientation of the coupling nipple 5 and of the outer sleeve 6 is arranged such that the latch tongues 16 are aligned with their latch bosses 7 along a line running in the longitudinal direction of the pipe 1. At this place, the outer sleeve 6 has its least extent in the axial direction, see also FIG. 2. The pipe-facing bearing surface of the outer sleeve 6 bears everywhere smoothly against the surface of the pipe 1. The outer sleeve 6 also has a bearing shoulder 8, which is facing away from the bearing surface for the pipe. This bearing shoulder 8 can likewise be seen in FIG. 2. The bearing shoulder 8 limits the insertion of the coupling nipple 5 into the outer sleeve 3, as is represented in FIG. 1. Disposed between the outer sleeve 6 and the radial outer side of the coupling nipple 5 is a seal 9, which is partially accommodated in a V-shaped groove. This seal 9 has a shape which roughly corresponds to the shape of the outer sleeve 6, yet is configured shorter in the axial direction.

Inserted in the coupling nipple 5 is a connecting nipple 10, which rests with a flange 11 on a seal 12 accommodated in a circumferential recess in the coupling nipple 5. The inner side of the coupling nipple 5 forms a socket for the connecting nipple 10, this socket containing a bayonet recess 13, see FIG. 2, with which a bayonet projection 14 of the connecting nipple 10 combines.

In the region of that end of the coupling nipple 5 which is disposed within the pipe 1, between the front end of the connecting nipple 10 and the latch tongues 16 there is disposed an inner sleeve 17, which is intended to prevent the latch tongues 16 from springing back inward, to be precise especially in the event of the connecting nipple 10 being removed again from the coupling element 3.

FIG. 3 shows how the outer sleeve 3, the coupling nipple 5 and the inner sleeve 17 are put together before being fitted to the pipe 1. Firstly, the seal 9 is inserted between the outer sleeve 3 and the coupling nipple 5, which procedure is not represented in FIG. 3. Next this coupling element is brought nearer to the surface of the pipe and forced against it, whereupon the latch bosses 7 then spring inward until coming to bear against the rear side of the pipe wall. As a result of the shape of the pipe-facing bearing surface 18 of the outer sleeve 6, a self-centering is realized. Following this fitting, the connecting nipple 10 is then inserted from the right in FIG. 3, whereupon it then pushes the inner sleeve 17 ahead of it until the latter is positioned on the rear side of the latch bosses 7.

1. An arrangement for fitting a sanitary element to a pipe (1), comprising:
a coupling element having a coupling nipple for insertion into a hole in the pipe an outer sleeve surrounding the coupling nipple and having a bearing surface for bearing contact against the pipe outside the hole and a seal, and
further comprising a connecting nipple which is insertable into the coupling nipple.

2. The arrangement as claimed in claim 1, wherein the coupling nipple has at least one latch boss acting upon a rear side of having the hole.

3. The arrangement as claimed in claim 2, wherein the latch boss is configured on a latch tongue, which is configured such that the latch tongue springs inward.

4. The arrangement as claimed in claim 1, wherein the outer sleeve has a bearing shoulder for the coupling nipple which is oriented opposite orientated to the bearing surface that bears against the pipe.

5. The arrangement as claimed in claim 1, wherein the coupling nipple forms a socket for the connecting nipple.

6. The arrangement as claimed in claim 5, wherein the socket has a bayonet device.

7. The arrangement as claimed in claim 1, wherein at least one of the connecting nipple and/a socket is configured such that the connecting nipple in an inserted state, reaches at least into the hole in the pipe.

8. The arrangement as claimed in claim 2, wherein the coupling nipple * has two diametrically disposed latch bosses.

9. The arrangement as claimed in claim 8, wherein the connection between the outer sleeve and the coupling nipple is configured such that the latch bosses of the coupling nipple are situated at the place of least axial extent on the outer sleeve.

10. The arrangement as claimed in claim 1, comprising an inner sleeve insertable into the coupling nipple for blocking at least one latch tongue once the coupling nipple is inserted in the hole in the pipe.

11. The arrangement as claimed in claim 10, wherein the inner sleeve is displaceable into a correct position by insertion of the connecting nipple into a socket.

12. The arrangement as claimed in claim 1, wherein at least the coupling nipple and the outer sleeve are prefabricated as a structural unit.

13. The arrangement as claimed in claim 1, wherein the connecting nipple has a ball joint for fitting a side shower.

14. The arrangement as claimed in claim 1, wherein the connecting nipple has a hose coupling.

15. The arrangement as claimed in claim 1, wherein the coupling nipple forms a part of the sanitary element.

16. The arrangement as claimed in claim 1, wherein the coupling nipple is connected to the sanitary element.

17. The arrangement as claimed in claim 7, wherein the coupling nipple has diametrical latch bosses.

18. The arrangement as claimed in claim 12, wherein the inner sleeve is prefabricated as a structural unit with the coupling nipple and the outer sleeve.
